(19) United States
(12) Patent Application Publication
(10) Pub. No.: US 2013/0222453 A1
(43) Pub. Date: Aug. 29, 2013

(54) DROP GENERATOR AND POLING WAVEFORM APPLIED THERETO

(71) Applicant: Douglas Dean Darling, Portland, OR (US)

(72) Inventor: Douglas Dean Darling, Portland, OR (US)

(73) Assignee: XEROX CORPORATION, Norwalk, CT (US)

(21) Appl. No.: 13/403,762

(22) Filed: Feb. 23, 2012

(51) Int. Cl. B41J 29/38; B41J 2/045

(52) U.S. Cl. 347/10; 347/68

(57) ABSTRACT

A drop emitting apparatus may include a drop generator having a piezoelectric element and configured to receive a drop firing waveform having a drop firing voltage pulse during a drop ejection period. A poling waveform may be applied to the drop generator during a poling period that occurs before the drop ejection period, the poling waveform having a poling voltage pulse that has a longer duration than that of the drop firing voltage pulse.

### TECHNICAL FIELD

The disclosed technology relates to the field of drop emitting devices, and more particularly to a drop generator that includes a piezoelectric element.

### BACKGROUND

Drop on demand printing technology for producing printed media has been employed in commercial products such as ink jet printers and other types of printers, plotters, and facsimile machines. Generally, an image is formed by selective placement on a receiver surface of drops, e.g., drops of ink or other suitable material, emitted by a plurality of drop generators implemented within a printhead or a printhead assembly. For example, the printhead assembly and the receiver surface may be caused to move relative to each other, and drop generators may be controlled to emit drops at appropriate times, e.g., by an appropriate controller. The receiver surface can be a transfer surface or a print medium such as paper.

Despite continued advances in drop on demand printing technology, there remains a need for more voltage headroom to compensate for driver wearout, e.g., drift, over the life of a printhead as well as a greater margin for printhead-to-printhead variation in driver efficiency and increased flexibility in printhead design.

### BRIEF DESCRIPTION OF THE DRAWINGS

FIG. 1 illustrates an example of a drop-on-demand drop emitting apparatus in accordance with certain embodiments of the disclosed technology.

FIG. 2 illustrates an example of a drop generator that may be implemented in a drop emitting apparatus such as the drop emitting apparatus of FIG. 1.

FIG. 3 illustrates a first example of a drop firing waveform that may be applied to drive a drop generator such as the drop generator of FIG. 2.

FIG. 4 illustrates a second example of a drop firing waveform that may be applied to drive a drop generator such as the drop generator of FIG. 2.

FIG. 5 illustrates a first example of a poling waveform that may be applied to a piezoelectric element of a drop generator such as the drop generator of FIG. 2.

FIG. 6 illustrates a second example of a poling waveform that may be applied to a piezoelectric element of a drop generator such as the drop generator of FIG. 2.

FIG. 7 illustrates an example of a method of applying multiple waveforms to a drop generator such as the drop generator of FIG. 2.

### DETAILED DESCRIPTION

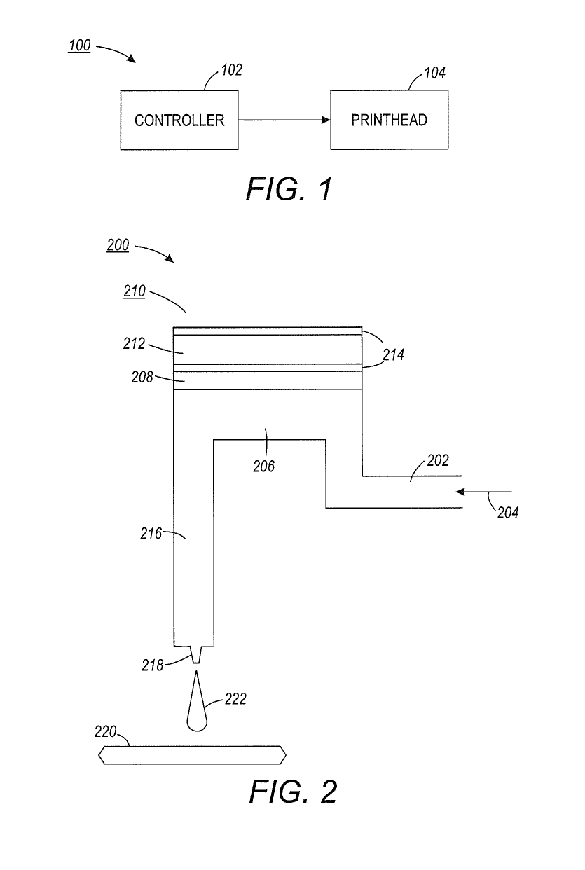

FIG. 1 illustrates an example of a drop-on-demand drop emitting apparatus 100 that includes a controller 102 and a printhead assembly 104 that may include a plurality of drop emitting drop generators. The controller 102 may selectively energize the drop generators by providing a respective drop firing waveform to each drop generator. Each of the drop generators may employ a piezoelectric transducer. As other examples, each of the drop generators may employ a shear-mode transducer, an annular constrictive transducer, an electrostrictive transducer, an electromagnetic transducer, or a magnetorestrictive transducer. The printhead assembly 104 may be formed of a stack of laminated sheets or plates, such as of stainless steel.

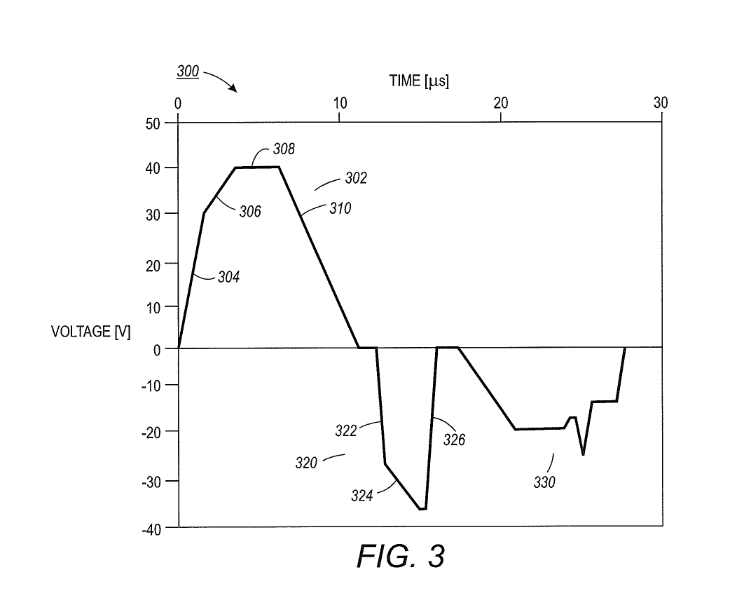

FIG. 2 illustrates an example of a drop generator 200 that may be implemented in a printhead assembly such as the printhead assembly 102 of the drop emitting apparatus 100 of FIG. 1. In the example, the drop generator 200 includes an inlet channel 202 that may receive ink 204 or other suitable material, such as three-dimensional printing material and printed circuit board (PCB) material, from a manifold, reservoir, or other structure configured to contain the material. The ink 204 or other material may flow into a pressure or pump chamber 206 that is bounded on one side, for example, by a flexible diaphragm 208. In the example, an electromechanical transducer 210 is attached to the flexible diaphragm 208 and may overlie the pressure chamber 206, for example.

The electromechanical transducer 210 may be a piezoelectric transducer that includes a piezoelectric element 212 disposed, for example, between two electrodes 214 that may receive signals, e.g., drop firing waveforms and poling waveforms, from a controller such as the controller 102 of the drop emitting apparatus of FIG. 1. Actuation of the electromechanical transducer 210 may cause the ink 204 or other material to flow from the pressure chamber 206 to a drop forming outlet channel 216, from which a drop 222 may be emitted toward a receiver medium 220, e.g., a transfer surface or print medium. The outlet channel 216 may include a nozzle or orifice 218. In certain embodiments, the ink 204 may be melted or phase changed solid ink, and the electromechanical transducer 210 may be a piezoelectric transducer that is operated in a bending mode, for example.

FIG. 3 illustrates a first example of a drop firing waveform 300 that may be applied to a drop generator such as the drop generator 200 of FIG. 2 during a drop ejection period to cause at least one drop, e.g., an ink drop, to be emitted therefrom. The time varying drop firing waveform 300 may be shaped or configured to actuate an electromechanical transducer of the drop generator such that the drop generator emits a drop, e.g., an ink drop.

The duration of the drop firing waveform 300 may be less than the drop ejection period, which may be in the range of about 100 microseconds to about 25 microseconds, such that the drop generator may be operated at a drop emitting frequency in the range of about 10 KHz to about 40 KHz, for example, wherein the period to eject a single drop is substantially equal to the reciprocal of the drop emitting frequency. The total duration of the waveform 300 may be in the range of about 20 microseconds to about 30 microseconds, for example.

In general, a drop firing waveform such as the drop firing waveform 300 of FIG. 3 comprises, in sequence, a first pulse having a first polarity, a second pulse having a second polarity, a delay, and a third pulse having the second polarity. In the example, the drop firing waveform 300 has in sequence a positive pulse component 302, a first negative pulse component 320, a delay 328, and a second negative pulse component 330. The pulses 302, 320, and 330 may be negative or positive relative to a reference such as zero volts. Each of the pulses 302, 320, and 330 may be characterized by a pulse duration as measured between the pulse transition times, i.e., the transition from the reference and the transition to the reference. Each of the pulses 302, 320, and 330 may also be characterized by a peak pulse magnitude that is a positive number.

The positive pulse 302 may have a duration in the range of about 10 microseconds to about 16 microseconds. The first negative pulse 320 may have a duration in the range of about 3 microseconds to about 7 microseconds. The second negative pulse 330 may have a duration in the range of about 2 microseconds to about 8 microseconds. In this manner, the positive pulse 302 may have a duration that is greater than the duration of the first negative pulse 320 and also greater than the duration of the second negative pulse 330. The duration of the second negative pulse 330 may be less than or greater than the duration of the first negative pulse 320. The duration of the first negative pulse 320 may be similar to that of the second negative pulse 330.

The positive pulse 302 may have a peak magnitude in the range of about 33 volts to about 47 volts. For example, the peak magnitude of the positive pulse 302 may be about 39 volts or less. In the example, the positive pulse 302 includes four segments: a first positive going segment 304, a second positive going segment 306, a substantially constant level segment 308, and a negative going segment 310. In the example, the first positive going segment 304 has a slope that is greater than that of the second positive going segment 306.

The first negative pulse 320 may have a peak magnitude in the range of about 30 volts to about 47 volts. For example, the peak magnitude of the first negative pulse 320 may be about 35 volts or less. The first negative pulse 320 may have a peak magnitude that is less than the peak magnitude of the positive pulse 302. In the example, the first negative pulse 320 includes four segments: a first negative going segment 322, a second negative going segment 324, and a positive going segment 326. In the example, the first negative going segment 322 has a slope that is greater than that of the second negative going segment 324.

The second negative pulse 330 may have a peak magnitude that is in the range of about 15 volts to about 47 volts. For example, the peak magnitude of the second negative pulse 330 may be about 22 volts or less. The second negative pulse 330 may have a peak magnitude that is less than the peak magnitude of the positive pulse 302 and is less than the peak magnitude of the first negative pulse 320. The second negative pulse 330 may be generally triangular or generally trapezoidal, for example.

In operation, the positive pulse 302 and the first negative pulse 320 cause a drop to be emitted from the drop generator by varying the volume of the pressure chamber, such as the pressure chamber 206 of the drop generator 200 of FIG. 2. The second negative pulse 330 generally occurs after a drop is emitted from the drop generator and may server to reset the drop generator so that subsequently emitted drops have substantially the same mass and velocity as the most recently emitted drop. The second negative pulse 330 is typically of the same polarity as the preceding first negative pulse 320, which tends to pull the meniscus at the nozzle, such as the nozzle 218 of the drop generator 200 of FIG. 2, inwardly to help prevent the meniscus from breaking. If the meniscus breaks and ink oozes out of the nozzle, for example, the drop generator may fail to emit drops on subsequent firings.

The delay 328 between the first negative pulse 320 and the second negative pulse 330 may be in the range of about 2 microseconds to about 7 microseconds.

The shape of the second negative pulse 330 may be selected such that (1) the correct amount of energy will be applied by the second negative pulse 330 to cancel the residual energy that remains in the drop generator after a drop is emitted, (2) the second negative pulse 330 will not itself fire a drop, and (3) the drop generator will not ingest an air bubble through the nozzle. By way of illustrative examples, the second negative pulse 330 may be generally triangular or generally trapezoidal. Other shapes may be employed.

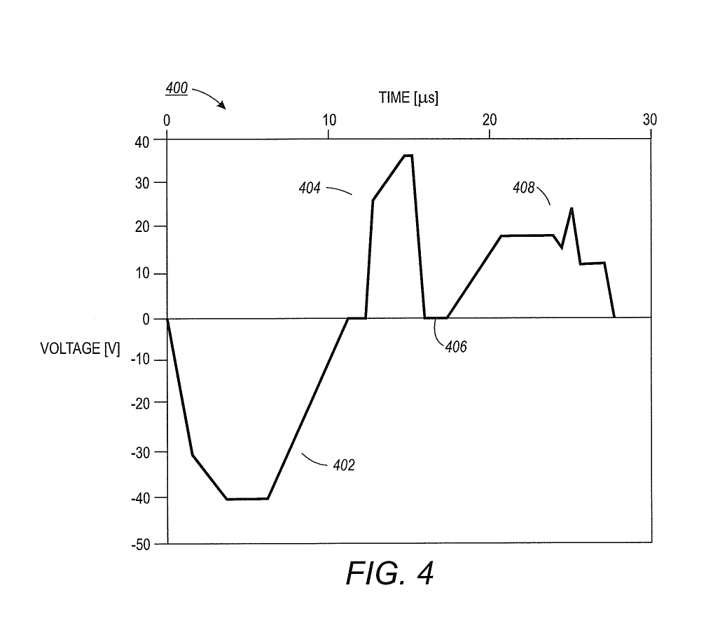

FIG. 4 illustrates a second example of a drop firing waveform 400 that may be applied to drive a drop generator such as the drop generator 200 of FIG. 2. The drop firing waveform 400 of FIG. 4 is generally of an opposite polarity from the drop firing waveform 300 of FIG. 3. The drop firing waveform 400 of FIG. 4 comprises a negative going pulse 402, a first positive going pulse 404, a delay 406, and a second positive going pulse 408. The durations and magnitudes of the pulses 402, 404, and 408 of the drop firing waveform 400 of FIG. 4 may be substantially the same as the durations and magnitudes of corresponding pulses 302, 320, and 330, respectively, of the drop firing waveform 300 of FIG. 3.

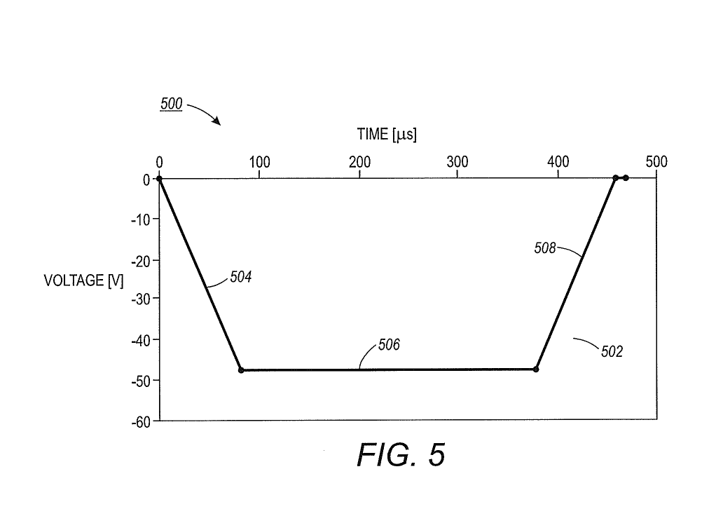

FIG. 5 illustrates a first example of a poling waveform 500 that may be applied to a piezoelectric element of a drop generator, such as the drop generator of FIG. 2, to pole the piezoelectric element. This poling is typically performed before the drop generator is to receive any drop firing waveforms. The poling waveform 500 may be applied to the piezoelectric element through two electrodes between which the piezoelectric element is disposed, such as the two electrodes 214 of FIG. 2, for example.

The poling waveform 500 of FIG. 5 includes a poling voltage pulse 502 and, in certain embodiments, includes multiple poling voltage pulses. The time varying poling voltage pulse 502 may be shaped or configured to pole or re-pole or assist with poling or re-poling the piezoelectric element of the drop generator. The poling voltage pulse 502 may be generally triangular or generally trapezoidal. Other shapes may be employed.

The poling voltage pulse 502 may have a duration that is longer than that of a drop firing voltage pulse, such as the drop firing voltage pulses 302, 320, and 330 of the drop firing waveform 300 of FIG. 3. For example, the duration of the poling voltage pulse 502 may have a range that is no less than 30 microseconds and, in certain embodiments, is at least substantially 300 microseconds. The poling waveform 500 may be applied to the piezoelectric element of the drop generator at a frequency that is no less than 2 kHz, for example. In alternative embodiments, the poling waveform 500 may be applied to the piezoelectric element of the drop generator at a frequency that is less than 2 kHz.

The poling voltage pulse 502 may have a peak magnitude of at least substantially 48 volts, for example. In certain embodiments, the peak magnitude of the poling voltage pulse 502 is at least substantially equivalent to a maximum voltage magnitude that the drop generator is capable of receiving.

In the example, the poling voltage pulse 502 includes three segments: a negative going segment 504, a substantially constant level segment 506, and a positive going segment 508. The negative going segment 504 may have a voltage slope that is less steep than that of a segment of a drop firing waveform such as the first or second positive going segments 304 and 306 of the positive pulse 302 of the drop firing waveform of FIG. 3, for example. The positive going segment 508 may have a voltage slope that is less steep than that of a segment of a drop firing waveform such as the negative going segment 310 of the positive pulse 302 of the drop firing waveform of FIG. 3, for example.

In certain embodiments, the negative going segment 504 of the poling voltage pulse 502 may have a voltage slope that is substantially identical in magnitude to that of the positive going segment 508. In other embodiments, the magnitude of the voltage slopes of the negative going segment 504 and the positive going segment 508 may be different.

In certain embodiments, the negative going segment 504 may have a voltage slope that is no greater than 10 V/μs and, in certain embodiments, is at least substantially 0.6 V/μs. The positive going segment 508 may also have a voltage slope that is no greater than 10 V/μs and, in certain embodiments, is at least substantially 0.6 V/μs.

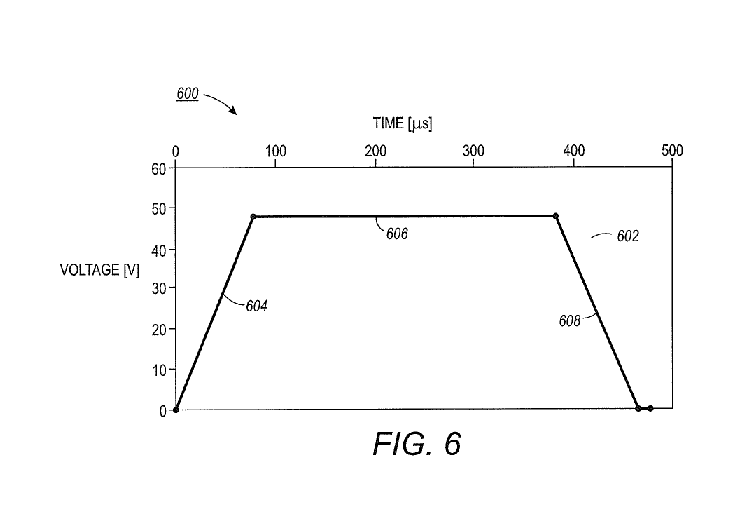

FIG. 6 illustrates a second example of a poling waveform 600 having at least one poling voltage pulse 602 that may be applied to a piezoelectric element of a drop generator such as the drop generator of FIG. 2. The poling waveform 600 of FIG. 6 is generally of an opposite polarity from the poling waveform 500 of FIG. 5. For example, whereas the poling voltage pulse 502 of the poling waveform 500 of FIG. 5 has a negative polarity, the poling voltage pulse 602 of the poling waveform 600 of FIG. 6 has a positive polarity. The duration and voltage magnitude of the poling waveform 600 of FIG. 6 may be substantially the same as the duration and voltage magnitude of the poling waveform 500 of FIG. 5.

The poling waveform 600 of FIG. 6 comprises a positive going segment 604, a substantially constant level segment 606, and a negative going segment 608. The voltage slopes of the positive going segment 604 and the negative going segment 608 may be at least substantially identical in magnitude to the voltage slopes of the negative going segment 504 and the positive going segment 508, respectively, of the poling waveform 500 of FIG. 5.

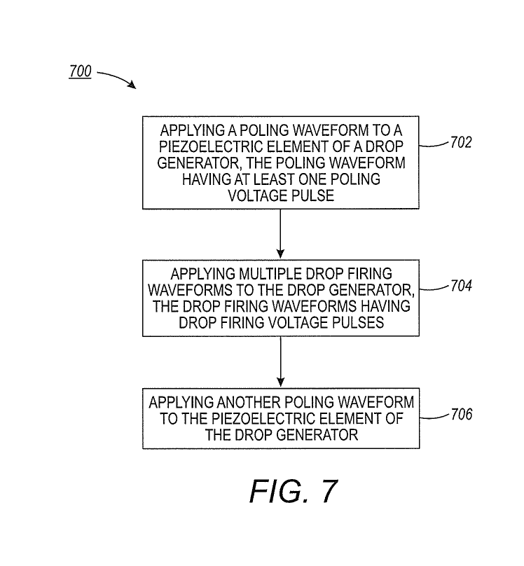

FIG. 7 illustrates an example of a method 700 of applying multiple waveforms to a drop generator such as the drop generator of FIG. 2. At 702, a poling waveform, such as the poling waveforms 500 and 600 of FIGS. 5 and 6, respectively, is applied to a piezoelectric element of the drop generator to pole the piezoelectric element during a poling period. The poling period generally occurs before a drop ejection period.

The poling waveform applied at 702 includes at least one poling voltage pulse, such as the poling voltage pulses 502 and 602 of the poling waveforms 500 and 600 of FIGS. 5 and 6, respectively. In certain embodiments, the poling waveform includes multiple poling voltage pulses that may be at least substantially similar to each other in duration, peak voltage magnitude, or both.

At 704, multiple drop firing waveforms, such as the drop firing waveforms 300 and 400 of FIGS. 3 and 4, respectively, are applied to the drop generator during a drop ejection period. The drop ejection period generally occurs subsequent to the piezoelectric element poling period. The drop firing waveforms may each have multiple drop firing voltage pulses, such as the pulses 302, 320, and 330 of the drop firing waveform 300 of FIG. 3.

At 706, another poling waveform having at least one re-poling voltage pulse is applied to the piezoelectric element of the drop generator during a re-poling period. The re-poling period generally occurs after at least one drop ejection period. The re-poling at 706 may occur responsive to a manual command or automatically based on any of a number of criteria, such as measured lifetime of the piezoelectric element and/or other components of the drop generator, amount of time since the original poling period, number of drop ejection periods since the original poling period, etc.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A drop emitting apparatus, comprising:
a drop generator comprising a piezoelectric element, wherein the drop generator is configured to receive a drop firing waveform during a drop ejection period, the drop firing waveform comprising at least one drop firing voltage pulse; and
a poling waveform applied to the drop generator during a poling period that occurs before the drop ejection period, the poling waveform comprising a poling voltage pulse having a duration that is longer than that of the at least one drop firing voltage pulse.

2. The drop emitting apparatus of claim 1, wherein the poling voltage pulse comprises a first voltage slope that is less steep than that of the at least one drop firing voltage pulse.

3. The drop emitting apparatus of claim 2, wherein the first voltage slope of the poling voltage pulse is no greater than 10 V/μs.

4. The drop emitting apparatus of claim 3, wherein the first voltage slope of the poling voltage pulse is at least substantially 0.6 V/μs.

5. The drop emitting apparatus of claim 2, wherein the poling voltage pulse comprises a second voltage slope that is less steep than that of the at least one drop firing voltage pulse.

6. The drop emitting apparatus of claim 5, wherein the second voltage slope of the poling voltage pulse is no greater than 10 V/μs.

7. The drop emitting apparatus of claim 6, wherein the second voltage slope of the poling voltage pulse is at least substantially 0.6 V/μs.

8. The drop emitting apparatus of claim 1, wherein the duration of the poling voltage pulse is no less than 30 μs.

9. The drop emitting apparatus of claim 8, wherein the duration of the poling voltage pulse is at least substantially 300 μs.

10. The drop emitting apparatus of claim 1, wherein the piezoelectric element is disposed between two electrodes and configured to receive the poling waveform through the two electrodes.

11. The drop emitting apparatus of claim 1, wherein the poling waveform is applied to the piezoelectric element at a frequency that is no less than 2 kHz.

12. The drop emitting apparatus of claim 1, wherein the poling voltage pulse has a positive polarity.

13. The drop emitting apparatus of claim 1, wherein the poling voltage pulse has a negative polarity.

14. The drop emitting apparatus of claim 1, wherein the poling voltage pulse has a magnitude that is at least substantially equivalent to a maximum voltage magnitude that the drop generator is capable of receiving.

15. The drop emitting apparatus of claim 1, wherein the poling voltage pulse has a magnitude of at least substantially 48 V.

16. The drop emitting apparatus of claim 1, wherein the drop comprises at least one of a group consisting of: ink, three-dimensional printing material, and printed circuit board (PCB) material.

17. A method, comprising:
applying multiple drop firing waveforms to a drop emitting apparatus comprising a piezoelectric element during drop ejection periods, the drop firing waveforms comprising drop firing voltage pulses; and
applying a single poling waveform to the piezoelectric element of the drop emitting apparatus during a poling period, the poling waveform comprising multiple poling voltage pulses each having a duration that is longer than that of the drop firing voltage pulses, wherein the poling period occurs before the drop ejection periods.

18. The method of claim 17, further comprising applying another single poling waveform to the drop emitting apparatus during a re-poling period, wherein the re-poling period occurs after at least one of the drop ejection periods.

19. The method of claim 17, wherein the poling voltage pulse comprises a first voltage slope that is less steep than that of the at least one drop firing voltage pulse.

20. The method of claim 19, wherein the poling voltage pulse comprises a second voltage slope that is less steep than that of the at least one drop firing voltage pulse.

21. The method of claim 17, wherein the poling waveform is applied to the piezoelectric element at a frequency that is no less than 2 kHz.

22. The method of claim 17, wherein the poling voltage pulse has a positive polarity.

23. The method of claim 17, wherein the poling voltage pulse has a negative polarity.

24. The method of claim 17, wherein the poling voltage pulse has a magnitude that is at least substantially equivalent to a maximum voltage magnitude that the drop generator is capable of receiving.

25. The method of claim 17, wherein the poling voltage pulse has a magnitude of at least substantially 48 V.
